(19) United States
(12) Patent Application Publication
(10) Pub. No.: US 2022/0274554 A1
(43) Pub. Date: Sep. 1, 2022

(54) VEHICLE SEAT AIRBAG

(71) Applicant: Ford Global Technologies, LLC, Dearborn, MI (US)

(72) Inventors: Dean M. Jaradi, Macomb, MI (US); Mohammad Omar Faruque, Ann Arbor, MI (US); S.M. Iskander Farooq, Novi, MI (US)

(73) Assignee: Ford Global Technologies, LLC, Dearborn, MI (US)

(21) Appl. No.: 17/188,402

(22) Filed: Mar. 1, 2021

(51) Int. Cl. B60R 21/207; B60R 21/205; B60R 21/231; B60R 21/2165; B60R 21/0136; B60R 21/015

(52) U.S. Cl. CPC B60R 21/207; B60R 21/205; B60R 21/231; B60R 21/2165; B60R 21/0136; B60R 21/01554; B60R 2021/2076; B60R 2021/01013

(57) ABSTRACT

A seat includes a seat bottom and a seatback supported by the seat bottom. The seatback is pivotable relative to the seat bottom. The seatback includes a front defining an occupant seating area. An airbag is supported by the seatback and is inflatable to an inflated position. The airbag extends from the front into the occupant seating area in the inflated position. A computer has a processor and a memory storing instructions executable by the processor to control inflation of the airbag based on an angle of the seatback relative to the seat bottom.

### BACKGROUND

Vehicles typically include a passenger cabin to house occupants of the vehicle. A vehicle, for example, may be an autonomous vehicle that may be driven without constant attention from a driver, i.e., the vehicle may be self-driving without human input. The passenger cabin of a vehicle typically includes one or more seats in various configurations. Vehicles are often provided with restraints. With the emergence of autonomous and semi-autonomous vehicles, additional solutions may be beneficial for monitoring and protecting the occupants in the various configurations that may be possible within the vehicles.

Each seat typically includes a seatback and a seat bottom. The seatback is supported by the seat bottom and may be moveable relative to the seat bottom. The seatback and the seat bottom are often adjustable in multiple degrees of freedom. For example, the seatback may be reclined relative to the seat bottom. In such an example, an occupant may sleep with the seat in a reclined position. While occupying a seat that is reclined past a certain angle when the vehicle is in motion may raise safety concerns, it is anticipated that future technology may render such activity permissible.

### BRIEF DESCRIPTION OF THE DRAWINGS

FIG. 1 is a perspective view of a restraint system including a seat having a seatback in a reclined position.

FIG. 2 is a perspective view of the restraint system of FIG. 1 including an airbag supported by the seatback in an inflated position.

FIG. 3A is a side view of the restraint system of FIG. 2.

FIG. 3B is a side view of the restraint system including the seat having the seatback in an upright position and the airbag in an uninflated position.

FIG. 4A is a perspective view of the seat including the airbag in the uninflated position.

FIG. 4B is a perspective view of the seat including the airbag in the inflated position.

FIG. 5 is a block diagram of a control system of a vehicle.

### DETAILED DESCRIPTION

A restraint system includes a seat having a seat bottom and a seatback supported by the seat bottom. The seatback is pivotable relative to the seat bottom. The seatback includes a front defining an occupant seating area. The restraint system includes an airbag supported by the seatback and being inflatable to an inflated position. The airbag extends from the front into the occupant seating area in the inflated position. The restraint system includes a computer having a processor and a memory storing instructions executable by the processor to control inflation of the airbag based on an angle of the seatback relative to the seat bottom. Although current airbag designs pose a risk of injury from a deploying airbag to an occupant who is not properly restrained or who is otherwise out of position at the time of deployment, it is anticipated that the future evolution of airbag technology may mitigate that risk.

The instructions may further include instructions to inflate the airbag in response to detecting a vehicle impact and the angle being greater than a predetermined angle.

The instructions may further include instructions to prevent inflation of the airbag in response to detecting the angle being less than or equal to a predetermined angle.

The seatback may define a cross-seat axis. The airbag in the inflated position may be elongated along the seatback transverse to the cross-seat axis. The seatback may include two sides spaced from each other along the cross-seat axis. The airbag in the inflated position may extend along the seatback from one side to the other side. The airbag in the inflated position may have a semi-circular shape in cross-section along the cross-seat axis. The seatback may include a top and a bottom spaced from the top along a vertical-seat axis transverse to the cross-seat axis. The airbag in the inflated position may be spaced from the top and the bottom of the seatback. The airbag in the inflated position may be disposed closer to the top of the seatback than to the bottom of the seatback. The airbag in the inflated position may include an impact panel disposed in the occupant seating area. The impact panel may be concave relative to the cross-seat axis.

The front of the seatback may include a tear seam disposed adjacent to the airbag. The airbag may extend through the tear seam in the inflated position.

The airbag may be spaced from the seat bottom.

The seatback may define a cross-seat axis. The airbag in the inflated position may include an impact panel that is disposed in the occupant seating area and concave relative to the cross-seat axis.

The seatback may define a cross-seat axis and may include two sides spaced from each other along the cross-seat axis. The airbag in the inflated position may extend along the seatback from one side to the other side.

The seatback may define a cross-seat axis. The airbag in the inflated position may have a semi-circular shape in cross-section along the cross-seat axis.

The seatback may include a top and a bottom spaced from each other. The airbag in the inflated position may be spaced from the top and the bottom of the seatback. The airbag in the inflated position may be disposed closer to the top of the seatback than to the bottom of the seatback.

The restraint system may include a dash vehicle-forward of the seat and a second airbag supported by the dash. The second airbag may be inflatable into the occupant seating area to an inflated state. The second airbag in the inflated state may be spaced from the airbag in the inflated position. The instructions may further include instructions to initiate inflation of the second airbag prior to initiating inflation of the airbag in response to detecting a vehicle impact and the angle being greater than or equal to a predetermined angle. The instructions may further include instructions to initiate inflation of the second airbag in response to detecting a vehicle impact. The instructions may further include instructions to prevent inflation of the airbag and initiate inflation of the second airbag in response to detecting the vehicle impact and the angle being less than a predetermined angle.

With reference to the Figures, wherein like numerals indicate like parts throughout the several views, a vehicle 10 is generally shown. The vehicle 10 includes a restraint system 12. The restraint system 12 includes a seat 14 having a seat bottom 16 and a seatback 18 supported by the seat bottom 16. The seatback 18 is pivotable relative to the seat bottom 16. The seatback 18 includes a front 20 defining an occupant seating area 22. The restraint system 12 includes an airbag 24 supported by the seatback 18. The airbag 24 is inflatable to an inflated position. The airbag 24 extends from the front 20 into the occupant seating area 22 in the inflated position. The restraint system 12 includes a computer 26 having a processor and a memory storing instructions executable by the processor to control inflation of the airbag 24 based on an angle α of the seatback 18 relative to the seat bottom 16.

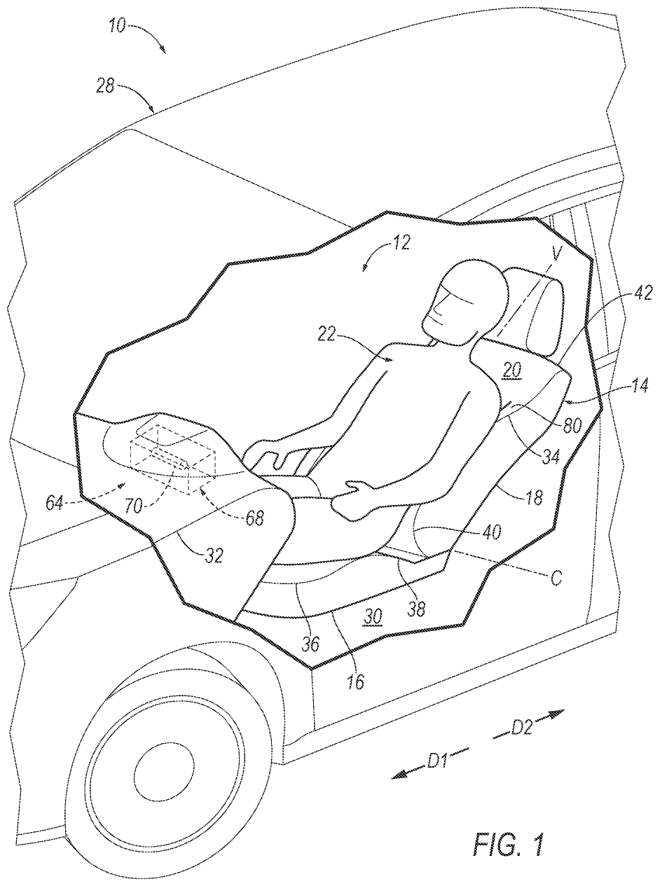

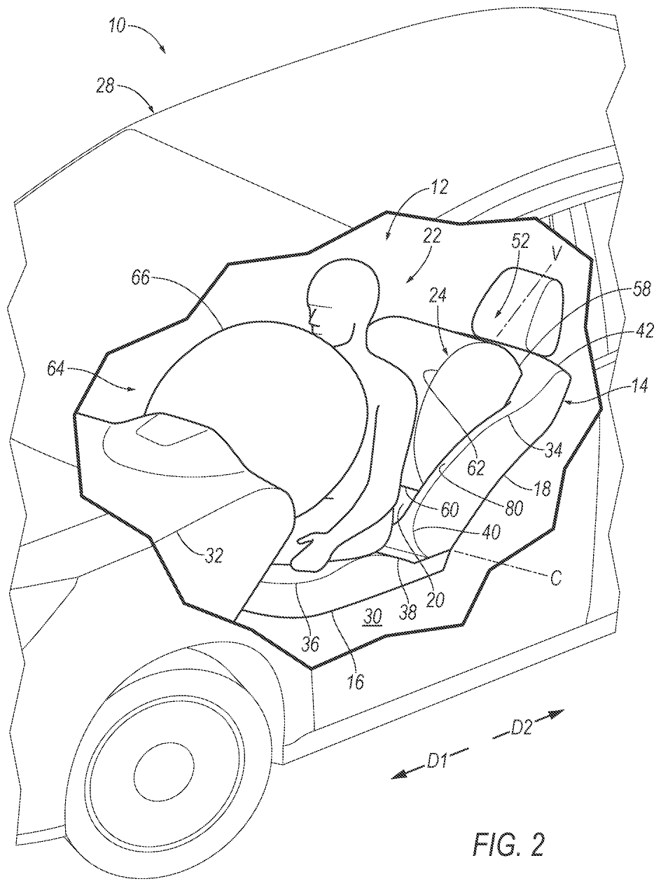

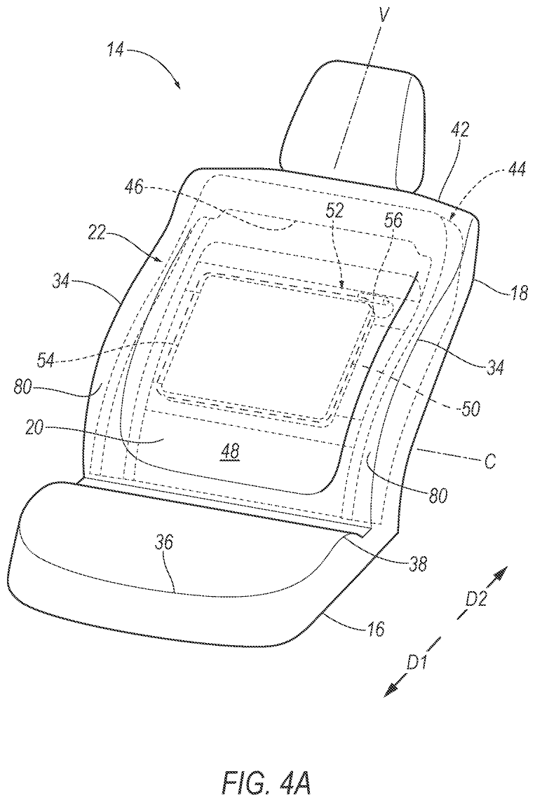

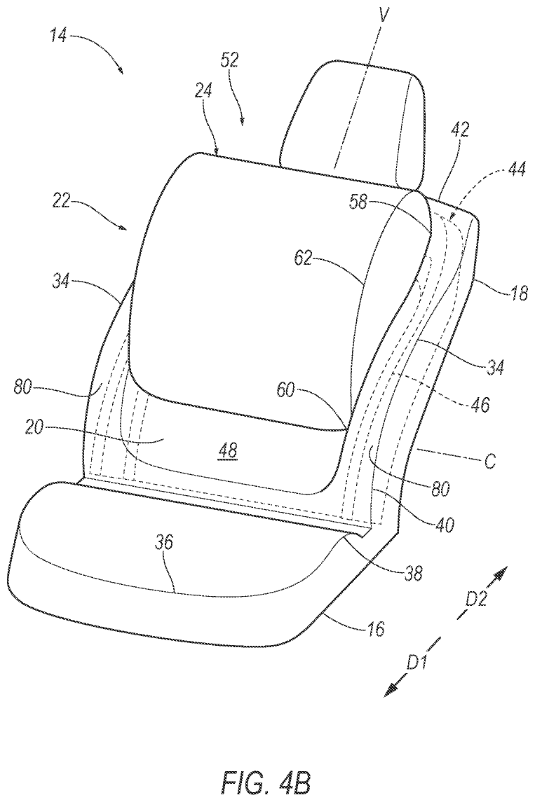

During a vehicle impact, the seatback 18 may be in any angular position relative to the seat bottom 16, as described further below. When the angle α of the seatback 18 relative to the seat bottom 16 is greater than a predetermined angle during the vehicle impact, the airbag 24 may be inflated from an uninflated position, as shown in FIGS. 1 and 4A, to an inflated position, as shown in FIGS. 2, 3A, and 4B. During the vehicle impact, the occupant may be forced into the airbag 24 in the inflated position. During the vehicle impact, the airbag 24 may provide coverage so as to control the kinematics of the occupant. By inflating the airbag 24 when the angle α of the seatback 18 relative to the seat bottom 16 is greater than the predetermined angle, the restraint system 12 may increase the likelihood that the occupant's kinematics are controlled regardless of the angular position of the seatback 18.

With reference to FIG. 1, the vehicle 10 may be any type of passenger or commercial automobile such as a car, a truck, a sport utility vehicle, a crossover, a van, a minivan, a taxi, a bus, etc. The vehicle 10, for example, may be an autonomous vehicle. In other words, the vehicle 10 may be autonomously operated such that the vehicle 10 may be driven without constant attention from a driver, i.e., the vehicle 10 may be self-driving without human input.

With reference to FIG. 1, the vehicle 10 may include a body 28 defining a passenger cabin (not numbered) to house occupants, if any, of the vehicle 10. The body 28 may include a roof (not numbered) and a floor 30 with the roof defining an upper boundary of the passenger cabin and the floor 30 defining a lower boundary of the passenger cabin. The body 28 includes doors openable to allow ingress to and egress from the passenger cabin.

The passenger cabin may extend across the vehicle 10, i.e., from one side to the other side of the vehicle 10. The passenger cabin includes a front end (not numbered) and a rear end (not numbered) with the front end being in front of the rear end during forward movement of the vehicle 10. The passenger cabin includes one or more seats 14. The seats 14 may be arranged in any suitable arrangement. For example, one or more of the seats 14 may be at the front end of the passenger cabin, i.e., a front seat, and/or one or more of the seats 14 may be at the rear end of the passenger cabin, i.e., a rear seat.

The body 28 may include at least one dash 32. In the example shown in the Figures, the body 28 includes one dash 32 at the front end of the passenger cabin. In addition or in the alternative, the body 28 may include another dash 32 at the rear end of the passenger cabin. The dash 32 may also be called a bulkhead or an instrument panel.

The dash 32 may extend completely across the passenger cabin, i.e., from one side to the other side of the vehicle 10. The dash 32 may extend downwardly from a windshield to the floor 30 of the passenger cabin. The dash 32 may be in front of the seats 14, e.g., at the front end of the passenger cabin, as shown in FIGS. 1-3B. In such an example, the dash 32 faces the seats 14. The dash 32 may, for example, include a class-A surface, i.e., a surface specifically manufactured to have a high quality, finished aesthetic appearance free from blemishes.

The dash 32 may include vehicle controls, such as gauges, dials, screens, and information displays; heating and ventilation equipment; a radio and other electronics; etc. The dash 32, as well as the rest of the vehicle 10, may lack a steering wheel and may lack pedals for accelerating and braking. In other words, as shown in the Figures, no steering wheel or pedals for accelerating and braking are supported by or adjacent to the dash 32. More specifically, the vehicle 10 does not include a steering wheel or pedals for accelerating and braking, e.g., the vehicle 10 is autonomous.

With reference to the Figures, the seatback 18 may be supported by the seat bottom 16 and may be movable relative to the seat bottom 16. The seatback 18 and the seat bottom 16 may be adjustable in multiple degrees of freedom. Specifically, the seatback 18 and the seat bottom 16 may themselves be adjustable, in other words, adjustable components within the seatback 18 and/or the seat bottom 16 may be adjustable relative to each other.

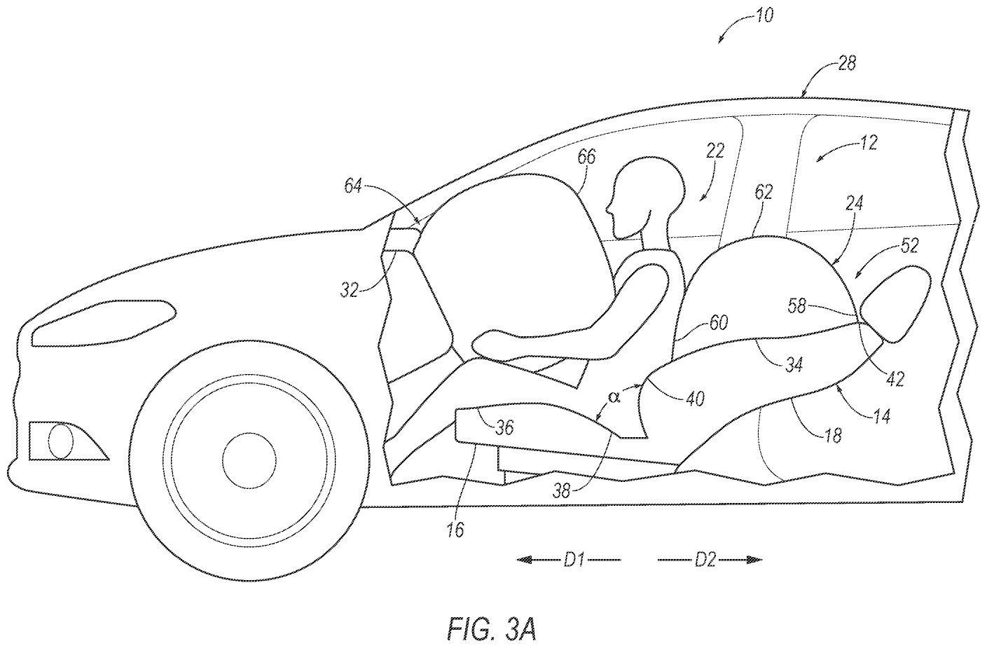

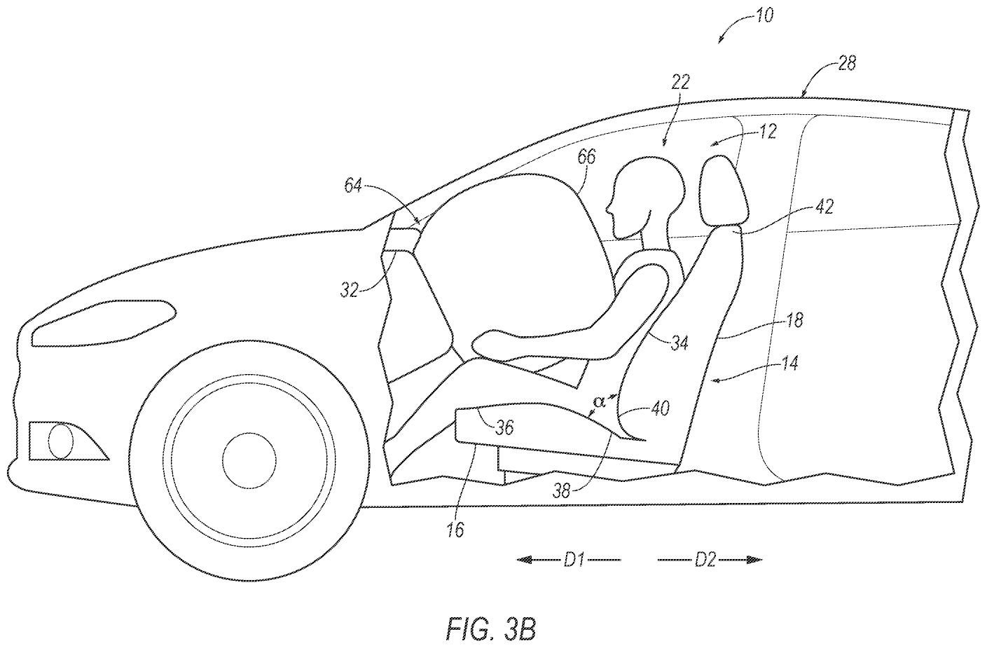

The seatback 18 may be pivotable relative to the seat bottom 16 to a plurality of angular positions. In other words, the seatback 18 may be disposed in any suitable angular position relative to the seat bottom 16. For example, the seatback 18 may be in an upright position. In other words, the seatback 18 may be generally upright, i.e., orthogonal, relative to the seat bottom 16, as shown in FIG. 3B. As another example, the seatback 18 may be in a reclined position. In other words, the seatback 18 may be reclined relative to the seat bottom 16, as shown in FIGS. 1-3A and 4A-4B. In such an example, the seatback 18 may be oblique, i.e., neither parallel nor perpendicular, to the seat bottom 16. Alternatively, the seatback 18 may be parallel to the seat bottom 16. The seatback 18 may be releasably fixed in position relative to the seat bottom 16 at a selected one of the plurality of angular positions in any suitable way.

The seat 14 defines a seat-forward direction D1 and a seat-rearward direction D2. The seat-forward direction D1 extends forward relative to the seat 14. For example, the seat-forward direction D1 may extend from a rear of the seat 14 to a front of the seat 14 relative to an occupant of the seat 14, i.e., the occupant of the seat 14 faces in the seat-forward direction D1. The seat-rearward direction D2 extends rearward relative to the seat 14, e.g., from the front of the seat 14 to the rear of the seat 14 relative to the occupant of the seat 14. In other words, the seat-rearward direction D2 extends in an opposite direction than the seat-forward direction D1.

Each seat 14 is supported by the floor 30, as shown in FIG. 1. Each seat 14 may slide relative to the floor 30, e.g., in the seat-forward direction D1 or the seat-rearward direction D2. In such an example, the seat 14 may be supported on a seat track (not shown) to allow the seat 14 to move in the seat-forward direction D1 or the seat-rearward direction D2. The seat 14 may be selectively slidable relative to the seat track. In other words, the occupant may slide the seat 14 along the seat track and may secure the seat 14 to the seat track at selected position. For example, the occupant may actuate a motor (not shown) that moves the seat 14 along the seat track. As another example, each seat 14 may be fixed relative to the floor 30. In this situation, the seat 14 may be immovable relative to the floor 30.

Additionally, or alternatively, each seat 14 may be rotatable relative to the floor 30. The seats 14 may include any suitable structure for rotating the respective seat 14 about a generally vertical axis, e.g., a rotatable post, rings rotatable relative to each other, etc. In other words, the seats 14 may be rotatable to face in different directions. For example, the seats 14 may rotate between a vehicle-forward position, a vehicle-rearward position, a vehicle-rightward position, a vehicle-leftward position, and/or positions therebetween. In the vehicle-forward position, an occupant of the seat 14 faces the dash 32, i.e., the seat-forward direction D1 generally aligns with a vehicle-forward direction. The seats 14 may rotate completely, i.e. 360° about the generally vertical axis. The seats 14 may rotate to face any number of directions.

The seat 14 defines a cross-seat axis C and a vertical-seat axis V transverse to the cross-seat axis C. The seat 14 includes two sides 34 spaced from each other along the cross-seat axis C, as shown in FIGS. 4A and 4B. The seat 14 may terminate at the sides 34. The sides 34 may support an occupant laterally relative to the seat 14. Each of the sides 34 may include a bolster 80. The bolsters 80 may extend in a direction that an occupant of the seat 14 would face, that is, in the seat-forward direction D1. The bolsters 80 may, for example abut the seat bottom 16 when the seatback 18 is in the upright position. Additionally, the bolsters 80 may be spaced from the seat bottom 16 when the seatback is in the reclined position.

As shown in the Figures, the seat bottom 16 includes a front end 36 and a back end 38. The seatback 18 is at the back end 38. The front end 36 is spaced from the back end 38 and the seatback 18. The seatback 18 extends across the seat bottom 16, e.g., from one side 34 of the seat 14 to the other side 34 of the seat 14, at the back end 38.

The seatback 18 includes a bottom 40 at the seat bottom 16 and a top 42 spaced from the bottom 40 and the seat bottom 16 along the vertical-seat axis V. For example, the top 42 may support a head restraint (not numbered), i.e., be disposed between the head restraint and the seat bottom 16. The front 20 of the seatback 18 extends from the bottom 40 to the top 42. Additionally, the front 20 of the seatback 18 extends from one side 34 of the seat 14 to the other side 34 of the seat 14.

The occupant seating area 22 is the area occupied by an occupant when seated on the seat bottom 16. The occupant seating area 22 is in the seat-forward direction D1 of the seatback 18 and above the seat bottom 16. That is, the front 20 of the seatback 18 faces the occupant seating area 22.

With reference to FIGS. 4A and 4B, the seat 14 includes a seat frame 44. The seat frame 44 includes a seatback frame 46 and a seat bottom frame (not shown). A hinge (not numbered) couples the seat bottom frame and the seatback frame 46 together. The hinge permits the seatback frame 46 to pivot relative to the seat bottom frame, as discussed above. The seat frame 44 may include panels and/or may include tubes, beams, etc. The seat frame 44 may be formed of any suitable plastic material, e.g., carbon fiber reinforced plastic (CFRP), glass fiber-reinforced semi-finished thermoplastic composite (organosheet), etc. Alternatively, for example, some or all components of the frame may be formed of a suitable metal, e.g., steel or aluminum.

With continued reference to FIGS. 4A and 4B, the seat 14 includes a covering 48 supported on the seat frame 44. The covering 48 may be cloth, leather, faux leather, or any other suitable material. The seat 14 may include padding material between the covering 48 and the seat frame 44. The padding material may be foam or any other suitable material. The covering 48 may be stitched in panels around the seat frame 44 and padding material.

With continued reference to FIGS. 4A and 4B, the seat 14, e.g., the covering 48, may include a tear seam 50. The tear seam 50 may be disposed on the front 20 of the seatback 18. For example, the tear seam 50 may extend along the seatback 18 adjacent to the airbag 24. Said differently, the airbag 24 may extend through the tear seam 50 in the inflated position. The tear seam 50 may have any suitable shape. For example, the tear seam 50 may have a rectangular shape, i.e., extending in lines forming a rectangle along the seat 14.

The tear seam 50 may be designed to tear apart when subjected to a tensile force above a threshold magnitude. In other words, the covering 48 on one side of the tear seam 50 separates from the covering 48 on the other side of the tear seam 50 when the force is above the threshold magnitude. The threshold magnitude may be chosen to be greater than forces from, e.g., inadvertent pushing against the seat 14 by an occupant but be less than forces from the deployment of the airbag 24. The tear seam 50 may be, for example, a line of perforations through the covering 48, a line of thinner covering 48 material than the rest of the covering 48, etc.

With continued reference to FIGS. 4A and 4B, the restraint system 12 includes a first airbag assembly 52, which includes the airbag 24, a first housing 54, and a first inflator 56. The seat 14 supports the first airbag assembly 52, and specifically, may support the airbag 24 when the airbag 24 is in the inflated position. The first airbag assembly 52 may be mounted to the seat 14, as discussed further below. The restraint system 12 may include any suitable number of first airbag assemblies 52, e.g., one or more. For example, the restraint system 12 may include a plurality of first airbag assemblies 52. In such an example, the restraint system 12 may include one first airbag assembly 52 for each front seat 14.

The first housing 54 houses the airbag 24 in the uninflated position, as shown in FIG. 4A, and supports the airbag 24 in the inflated position. The airbag 24 may be rolled and/or folded to fit within the first housing 54 in the uninflated position. The first housing 54 may be of any suitable material, e.g., a rigid polymer, a metal, a composite, or a combination of rigid materials. The first housing 54 may, for example, include clips, panels, etc. for attaching the airbag 24 and for attaching the first airbag assembly 52 to the seat 14.

The airbag 24 may be woven nylon yarn, for example, nylon 6-6. Other examples include polyether ether ketone (PEEK), polyetherketoneketone (PEKK), polyester, etc. The woven polymer may include a coating, such as silicone, neoprene, urethane, etc. For example, the coating may be polyorgano siloxane.

The airbag 24 may be a single continuous unit, e.g., a single piece of fabric. Alternatively, the airbag 24 may include a plurality of segments, i.e., two or more. The segments may be attached to each other in any suitable fashion, e.g., a plurality of panels attached by stitching, ultrasonic welding, etc.

The airbag 24 is supported by the seatback 18 of the seat 14. For example, the first airbag assembly 52 may be supported by the front 20 of the seatback 18, as shown in FIGS. 4A and 4B. Specifically, the first airbag assembly 52 may be fixed to the seatback frame 46. The airbag 24 may, for example, be disposed in the seatback 18 in the uninflated position, i.e., between the covering 48 and the seatback frame 46, as shown in FIG. 4A. In other words, the covering 48 may cover the airbag 24 in the uninflated position.

In the inflated position, the airbag 24 may extend through the seatback 18, e.g., the tear seam 50 adjacent to the airbag 24, as shown in FIGS. 2, 3A, and 4B. In this situation, the airbag 24 may extend into the occupant seating area 22. That is, the airbag may extend towards the occupant of the seat 14, i.e., away from the front 20 of the seatback 18, in the inflated position. Additionally, the airbag 24 may extend along the cross-seat axis C in the inflated position. For example, the airbag 24 may extend from one side 34 of the seat 14 to the other side 34 of the seat 14. As another example, the airbag 24 may be spaced from at least one of the sides 34.

In the inflated position, the airbag 24 may be disposed between, i.e., spaced from, the top 42 and the bottom 40 of the seatback 18. For example, the airbag 24 may be disposed closer to the top 42 of the seatback 18 than to the bottom 40 of the seatback 18, as shown in FIGS. 2, 3A and 4B. Alternatively, the airbag 24 may extend to at least one of the top 42 and the bottom 40 of the seatback 18 in the inflated position. In the inflated position, the airbag 24 may be spaced from the seat bottom 16.

With reference to FIG. 4B, the airbag 24 may include a top 58 and a bottom 60 spaced from the top 58 along the vertical-seat axis V. The airbag 24 may be elongated along the seatback 18 from the top 58 to the bottom 60 of the airbag 24, i.e., transverse to the cross-seat axis C. In other words, the longest dimension of the airbag 24 along the seatback 18 may be along the vertical-seat axis V. The top 58 of the airbag 24 may be disposed between the bottom 60 of the airbag 24 and the top 42 of the seatback 18, and the bottom 60 of the airbag 24 may be disposed between the bottom 40 of the seatback 18 and the top 58 of the airbag 24.

With continued reference to FIG. 4B, the airbag 24 may include a plurality of panels, including a panel 62 extending from the top 58 to the bottom 60 of the airbag 24. Each of the panels may extend transverse to each other in the inflated position. In the inflated position, the panel 62 extends into the occupant seating area 22 to control kinematics of the occupant. The panel 62 may extend any suitable amount into the occupant seating area 22. The panel 62 is positioned to receive and be impacted by the occupant, e.g., a torso and a head, when the airbag 24 is inflated during an impact that urges the occupant toward the airbag 24. In other words, the panel 62 may be referred to as an “impact panel.”

The panels may define an inflation chamber therebetween. During inflation, the inflation chamber may be inflated from the uninflated position to the inflated position. For example, the panel 62 may be in fluid communication with the inflation chamber. In this situation, the panel 62 may be pushed upwardly away from the first housing 54 by gas flow in the inflation chamber of the airbag 24 during inflation of the airbag 24.

In the inflated position, the panel 62 may be concave relative to the cross-seat axis C. For example, the panel 62 may include an apex (not numbered) disposed in the occupant seating area 22 and spaced from the front 20 of the seatback 18. The apex may be disposed at any suitable position along the vertical-seat axis V, i.e., between the top 42 and the bottom 40 of the seatback 18. For example, the apex may be disposed on a midline between, i.e., equidistant from, the top 58 and the bottom 60 of the airbag 24. In such an example, the airbag 24 may have a semi-circular shape in cross-section along the cross-seat axis C, as shown in FIG. 3A. As another example, the apex may be disposed closer to one of the top 58 or the bottom 60 of the airbag 24 than to the other of the top 58 or the bottom 60 of the airbag 24.

The airbag 24 may include a plurality of internal tethers (not shown) disposed in the inflation chamber. The internal tethers may extend across the inflation chamber, e.g., from the first housing 54 to the panel 62. The internal tethers may be fixed, e.g., via stitching, ultrasonic welding, etc., to the first housing 54 and the panel 62 in the inflation chamber. The internal tethers may be any suitable material, e.g., a same material as the airbag 24. The internal tethers may be positioned to control the shape of the airbag 24.

The first inflator 56 is in fluid communication with the airbag 24. The first inflator 56 expands the airbag 24 with inflation medium, such as a gas, to move the airbag 24 from the uninflated position to the inflated position. The first inflator 56 may be supported by the first housing 54, as shown in the Figures, or any other suitable component in the vehicle 10, e.g., the seatback 18 of the seat 14. The first inflator 56 may be, for example, a pyrotechnic inflator that ignites a chemical reaction to generate the inflation medium, a stored gas inflator that releases (e.g., by a pyrotechnic valve) stored gas as the inflation medium, or a hybrid. The first inflator 56 may be, for example, at least partially in the inflation chamber to deliver inflation medium directly to the inflation chamber or may be connected to the inflation chamber through fill tubes, diffusers, etc.

The restraint system 12 may include a second airbag assembly 64 which includes a second airbag 66, a second housing 68, and a second inflator 70. The dash 32 may support the second airbag assembly 64, and specifically, may support the second airbag 66 when the second airbag 66 is in an inflated state. The second airbag assembly 64 may be mounted to the dash 32, as discussed further below. The restraint system 12 may include a same or different number of second airbag assemblies 64 and first airbag assemblies 52.

The second housing 68 houses the second airbag 66 in an uninflated state, as shown in FIG. 1, and supports the second airbag 66 in the inflated state. The second airbag 66 may be rolled and/or folded to fit within the second housing 68 in the uninflated state. The second housing 68 may be of any suitable material, e.g., a rigid polymer, a metal, a composite, or a combination of rigid materials. The second housing 68 may, for example, include clips, panels, etc. for attaching the second airbag 66 and for attaching the second airbag assembly 64 to the dash 32.

The second airbag 66 may be a same or different type of material as the airbag 24. The second airbag 66 may be a single continuous unit, e.g., a single piece of fabric. Alternatively, the second airbag 66 may include a plurality of segments, i.e., two or more. The segments may be attached to each other in any suitable fashion, e.g., a plurality of panels attached by stitching, ultrasonic welding, etc.

The second airbag 66 is supported by the dash 32 and disposed vehicle-forward of the seat 14. For example, the second airbag assembly 64 may be fixed to the dash 32, as shown in the Figures. The second airbag 66 may, for example, be disposed in the dash 32 in the uninflated state and may extend from and remain supported by the dash 32 in the inflated state.

The second airbag 66 inflates away from the dash 32 toward the occupant of the seat 14 in a vehicle-rearward direction, e.g., the seat-rearward direction D2. That is, the second airbag 66 inflates into the occupant seating area 22 of a seat 14, as shown in FIGS. 2 and 3A. The second airbag 66 is designed, i.e., sized, shaped, and positioned, to control kinematics of an occupant in the seat 14 during a vehicle impact. The second airbag 66 in the inflated state is spaced from the airbag 24 in the inflated position. Specifically, an occupant is disposed between the second airbag 66 in the inflated state and the airbag 24 in the inflated position, as shown in FIG. 3A. More specifically, the second airbag 66 is vehicle-forward of the occupant, and the airbag 24 is vehicle-rearward of the occupant. The second airbag 66 may be referred to as a driver airbag or a front passenger airbag.

The second inflator 70 is in fluid communication with the second airbag 66. The second inflator 70 expands the second airbag 66 with inflation medium, such as a gas, to move the second airbag 66 from the uninflated state to the inflated state. The second inflator 70 may be supported by the second housing 68, as shown in the Figures, or any other suitable component in the vehicle 10, e.g., the dash 32, the body 28, etc. The second inflator 70 may be a same or different type of inflator as the first inflator 56. The second inflator 70 may be, for example, at least partially in an inflation chamber to deliver inflation medium directly to the inflation chamber or may be connected to the inflation chamber through fill tubes, diffusers, etc.

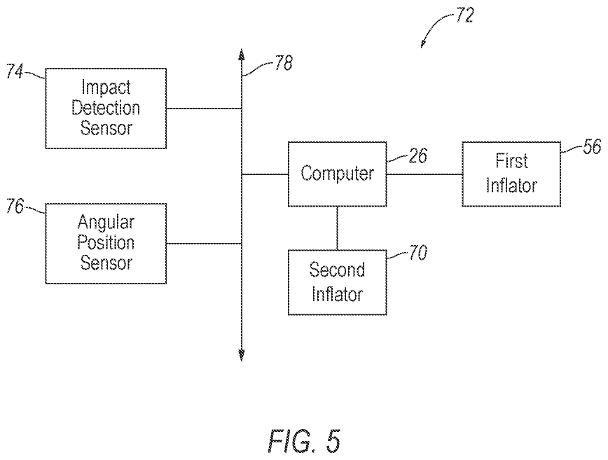

With reference to FIG. 5, the vehicle may include a control system 72. The control system 72 may include the computer 26, an impact detection sensor 74, an angular position sensor 76, the first airbag assembly 52, e.g., the first inflator 56, and the second airbag assembly 64, e.g., the second inflator 70, in communication through a communication network 78.

The angular position sensor 76 may be in communication with the computer 26. The angular position sensor 76 is programmed to detect an angular position of the seatback 18. That is, the angular position detects an angle α of the seatback 18 relative to the seat bottom 16, i.e., between an axis extending along the seatback 18 and an axis in the seat-forward direction D1 about the hinge. The control system 72 may include any suitable number of angular position sensors 76, e.g., one angular position sensor 76 for each seat 14. The angular position sensor 76 may be mounted to any suitable component of the vehicle 10, e.g., the seat 14, the floor 30, etc. The angular position sensors 76 may be any suitable sensor in the seat 14 (e.g., rotary encoders, Hall-effect sensors, etc.) or exterior to the seat 14 (including cameras, image sensors, etc.). The computer 26 may receive one or more signals from the angular position sensors 76 indicating the angular position of the seatback 18.

In an example in which the angular position sensor 76 is mounted to the seat 14, the angular position sensor 76 can include a base (not shown) fixed to seat bottom 16 and a rotor (not shown) fixed to the seatback 18. In such an example, as the seatback 18 pivots relative to the seat bottom 16, the rotor rotates relative to the base. The angular position sensor 76 can determine the angle α based on the rotation of the rotor relative to the base. In an example in which the angular position sensor 76 is an image sensor, the angular position sensor 76 can determine the angle α, e.g., using image processing techniques, based on detecting the front 20 of the seatback 18. For example, the front 20 may appear larger when the seatback 18 is upright relative to the seat bottom 16 as compared to when the seatback 18 is reclined relative to the seat bottom 16. That is, the angular position sensor 76 may detect more surface area of the front 20 of the seatback when the seatback 18 is upright than when the seatback 18 is reclined. The angular position sensor 76 can determine the angle α as a function of the size, i.e., the amount of surface area, of the front 20 detected in an image.

The impact detection sensor 74 may be in communication with the computer 26. The impact detection sensor 74 is programmed to detect an impact to the vehicle 10. The impact detection sensor 74 may be of any suitable type, for example, post-contact sensors such as accelerometers, pressure sensors, and contact switches; and pre-impact detection sensors such as radar, lidar, and vision-sensing systems. The vision systems may include one or more cameras, CCD image sensors, CMOS image sensors, etc. The impact detection sensor 74 may be located at numerous points in or on the vehicle 10.

The computer 26 may be a microprocessor-based computing device implemented via circuits, chips, or other electronic components. The computer 26 may include a processor, memory, etc. The memory of the computer 26 may store instructions executable by the processor and the processor may read the instructions from the memory and execute the instructions. The computer 26 may be, for example, a restraint control module (RCM).

The control system 72 may transmit signals through the communications network 78 such as a controller area network (CAN) bus, Ethernet, Local Interconnect Network (LIN), and/or by any other wired or wireless communications network.

The computer 26 may be programmed to control inflation of the airbag 24 based on the angular position of the seatback 18, e.g., regardless of a direction that the seat 14 faces. That is, the computer 26 may selectively initiate the first airbag assembly 52 in response to a detection of an angular position of the seatback 18, i.e., an angle α of the seatback 18 relative to the seat bottom 16, and detection of a sensed vehicle impact, e.g., a frontal impact. For example, the computer 26 can receive a notification from the angular position sensor 76 specifying an angle α of the seatback 18 relative to the seat bottom 16. The computer 26 can then compare the angle α to a predetermined angle. The predetermined angle may be stored, e.g., in a memory of the computer 26. The predetermined angle may be determined based on, e.g., empirical testing to determine test dummy reactions during an impact test with the seatback 18 in various angular positions. Upon determining that the angle α of the seatback 18 relative to the seat bottom 16 is greater than the predetermined angle, the computer 26 can then initiate inflation of the airbag 24 in response to detecting a vehicle impact. In other words, in examples in which the impact detection sensor 74 detects a vehicle impact, the computer 26 may send a signal to actuate the first inflator 56. In this situation, the first inflator 56 discharges inflation medium, which inflates the airbag 24.

Upon determining that the angle α of the seatback 18 relative to the seat bottom 16 is less than or equal to the predetermined angle, the computer 26 can prevent inflation of the airbag 24 in response to a detection of the vehicle impact. In other words, in examples in which the impact detection sensor 74 detects a vehicle impact, the computer 26 may send a signal to prevent inflation of the airbag 24. Alternatively, the computer 26 may not send a signal to the first inflator 56 upon detecting the angle α is less than or equal to the predetermined angle. In this situation, the airbag 24 is not inflated from the uninflated position to the inflated position during the vehicle impact. The airbag 24 is not inflated in this situation because the seatback 18 may control kinematics of the occupant when the angle α of the seatback 18 relative to the seat bottom 16 is less than or equal to the predetermined angle. Instead, the computer 26 may initiate inflation of other airbags, e.g., the second airbag 66, curtain airbags, side airbags, etc., in the vehicle 10.

The computer 26 may be programmed to initiate the second airbag assembly 64 in response to a detection of a sensed vehicle impact, e.g., a frontal impact. That is, the computer 26 may initiate inflation of the second airbag 66 regardless of the angular position of the seatback 18 relative to the seat bottom 16. In other words, in examples in which the impact detection sensor 74 detects a vehicle impact, the computer 26 may send a signal to actuate the second inflator 70. In this situation, the second inflator 70 discharges inflation medium, which inflates the second airbag 66.

In examples in which the computer 26 actuates the first inflator 56 and the second inflator 70, the computer 26 may be programmed to actuate the second inflator 70 prior to the first inflator 56. That is, the computer 26 may send a signal to initiate inflation of the second airbag 66 prior to sending a signal to initiate inflation of the airbag 24. The second inflator 70 may be actuated prior to the first inflator 56 because, during a vehicle impact, e.g., a frontal impact, an occupant of the seat 14 may move towards (e.g., due to momentum of the vehicle impact) and impact the second airbag 66 in the inflated state prior to moving towards and impacting the airbag 24 in the inflated position.

Computing devices, such as the computer 26, generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In operation, the airbag 24 is in the uninflated position, under normal operating conditions of the vehicle 10. In the event of a vehicle impact, the impact detection sensors 74 detect the impact. Additionally, the angular position sensors 76 detect the angular position of the seatback 18. The impact detection sensors 74 transmit a signal indicating the vehicle impact collision through the communication network 78 to the computer 26. Additionally, the angular position sensors 76 transmit a signal indicating the angular position of the seatback 18 through the communication network 78 to the computer 26. When the vehicle impact is detected and the angle α of the seatback 18 relative to the seat bottom 16 is greater than the predetermined angle, the computer 26 transmits a signal through the communication network 78 triggering the first inflator 56 to inflate the airbag 24 with inflation medium from the uninflated position to the inflated position. When the first inflator 56 inflates the airbag 24 to the inflated position, the inflation medium flows into the airbag 24, increasing the pressure in the airbag 24. As the pressure is increased in the airbag 24, the airbag 24 inflates through the front 20 of the seatback 18 and into the occupant seating area 22. As the occupant moves relative to the seat 14 due to momentum of the vehicle impact, the occupant moves towards the airbag 24, e.g., after impacting the second airbag 66. When the occupant impacts the airbag 24, the airbag 24 controls the kinematics of the occupant. By inflating the airbag 24 when the angle α of the seatback 18 relative to the seat bottom 16 is greater than the predetermined angle, the restraint system 12 controls the kinematics of the occupant regardless of the angular position of the seatback 18.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance or order. Many modifications and variations of the present disclosure are possible in light of the above teachings, and the disclosure may be practiced otherwise than as specifically described.

What is claimed is:

1. A restraint system, comprising:
a seat having a seat bottom and a seatback supported by the seat bottom, the seatback being pivotable relative to the seat bottom;
the seatback including a front defining an occupant seating area;
an airbag supported by the seatback and being inflatable to an inflated position, the airbag extending from the front into the occupant seating area in the inflated position; and
a computer having a processor and a memory storing instructions executable by the processor to control inflation of the airbag based on an angle of the seatback relative to the seat bottom.

2. The restraint system of claim 1, wherein the instructions further include instructions to inflate the airbag in response to detecting a vehicle impact and the angle being greater than a predetermined angle.

3. The restraint system of claim 1, wherein the instructions further include instructions to prevent inflation of the airbag in response to detecting the angle being less than or equal to a predetermined angle.

4. The restraint system of claim 1, wherein the seatback defines a cross-seat axis, the airbag in the inflated position being elongated along the seatback transverse to the cross-seat axis.

5. The restraint system of claim 4, wherein the seatback includes two sides spaced from each other along the cross-seat axis, the airbag in the inflated position extending along the seatback from one side to the other side.

6. The restraint system of claim 4, wherein the airbag in the inflated position has a semi-circular shape in cross-section along the cross-seat axis.

7. The restraint system of claim 4, wherein the seatback includes a top and a bottom spaced from the top along a vertical-seat axis transverse to the cross-seat axis, the airbag in the inflated position is spaced from the top and the bottom of the seatback.

8. The restraint system of claim 7, wherein the airbag in the inflated position is disposed closer to the top of the seatback than to the bottom of the seatback.

9. The restraint system of claim 4, wherein the airbag in the inflated position includes an impact panel disposed in the occupant seating area, the impact panel being concave relative to the cross-seat axis.

10. The restraint system of claim 1, wherein the front of the seatback includes a tear seam disposed adjacent to the airbag, the airbag extending through the tear seam in the inflated position.

11. The restraint system of claim 1, wherein the airbag is spaced from the seat bottom.

12. The restraint system of claim 1, wherein the seatback defines a cross-seat axis, the airbag in the inflated position including an impact panel that is disposed in the occupant seating area and concave relative to the cross-seat axis.

13. The restraint system of claim 1, wherein the seatback defines a cross-seat axis and includes two sides spaced from each other along the cross-seat axis, the airbag in the inflated position extending along the seatback from one side to the other side.

14. The restraint system of claim 1, wherein the seatback defines a cross-seat axis, the airbag in the inflated position having a semi-circular shape in cross-section along the cross-seat axis.

15. The restraint system of claim 1, wherein the seatback includes a top and a bottom spaced from each other, the airbag in the inflated position is spaced from the top and the bottom of the seatback.

16. The restraint system of claim 15, wherein the airbag in the inflated position is disposed closer to the top of the seatback than to the bottom of the seatback.

17. The restraint system of claim 1, further comprising a dash vehicle-forward of the seat and a second airbag supported by the dash, wherein the second airbag is inflatable into the occupant seating area to an inflated state, the second airbag in the inflated state being spaced from the airbag in the inflated position.

18. The restraint system of claim 17, wherein the instructions further include instructions to initiate inflation of the second airbag prior to initiating inflation of the airbag in response to detecting a vehicle impact and the angle being greater than or equal to a predetermined angle.

19. The restraint system of claim 17, wherein the instructions further include instructions to initiate inflation of the second airbag in response to detecting a vehicle impact.

20. The restraint system of claim 17, wherein the instructions further include instructions to prevent inflation of the airbag and initiate inflation of the second airbag in response to detecting the vehicle impact and the angle being less than a predetermined angle.
